(19) United States
(12) Patent Application Publication
(10) Pub. No.: US 2019/0110097 A1
(43) Pub. Date: Apr. 11, 2019

(54) SYSTEM AND METHOD FOR CONTROLLING THE PRESENTATION OF REMOTELY SOURCED CONTENT

(71) Applicant: Commercial Streaming Solutions Inc., Las Vegas, NV (US)

(72) Inventors: Seth Schorr, Las Vegas, NV (US); Sameer Mohan Gupta, Los Angeles, CA (US)

(21) Appl. No.: 16/151,814

(22) Filed: Oct. 4, 2018

Related U.S. Application Data
(60) Provisional application No. 62/568,361, filed on Oct. 5, 2017.
(60) Provisional application No. 62/657,099, filed on Apr. 13, 2018.

(51) Int. Cl. H04N 21/41; H04N 21/478; H04N 21/4722; H04L 29/06

(52) U.S. Cl. CPC H04N 21/4126; H04L 65/608; H04N 21/4722; H04N 21/478

(57) ABSTRACT

A method and system provide for user control over the presentation of data, video and/or audio content, including Internet or web-based content, such as streaming video, to one or more video displays and audio generating devices. The system includes a uniquely configured media control device which interfaces with multiple user devices to receive user selection of desired content. The content may include primary content and secondary content. In one configuration, the media control device controls individual display controllers associated with each display to cause the displays to display user-selected content. The invention has particular utility to bars and the like were the operator may allow patrons to select web-based content for display on displays with in the business.

### RELATED APPLICATION DATA

The present invention claims priority to U.S. Provisional Application Ser. No. 62/568,351, filed Oct. 5, 2017, and U.S. Provisional Application Ser. No. 62/657,099, filed Apr. 13, 2018. Each of said prior applications are incorporated by reference herein in their entirety.

### FIELD OF THE INVENTION

The present invention relates to systems and methods for controlling the distribution and presentation of remotely sourced data, visual and/or audio content.

### BACKGROUND OF THE INVENTION

In the past, video content such as television shows and movies were either provided via fixed media (such as CD, DVD, video tape and the like), or over the air or by dedicated distribution networks (such as cable and satellite networks), such as by using specialized receivers (such as cable TV receivers which are capable of receiving and decoding such contents for output to a subscriber's television).

Today, a wide variety of data, video and audio content is available online and can be accessed via an Internet accessible device such a home computer, a laptop, a tablet or a smart phone. These computing devices are capable of communicating with a webserver and then displaying the content provided by those webservers. In this configuration, each user uses their own dedicated computing device to access the remote webserver and then view the content on their device.

This existing configuration for accessing and viewing web content has a number of drawbacks. For example, a user of a smart phone might access web-based video content and view it on their phone. However, given the size of most smart phone displays, this arrangement is not well suited to allowing additional viewers to view the content, such as when the user is with a group of friends. Also, due to the screen size, the amount of information is limited as to what can be viewed.

“Smart” televisions have been developed which are capable of displaying web-based video content. These televisions have the advantage that the video content can be displayed on a large screen, such as for viewing by multiple viewers. However, these televisions still have a number of drawbacks. First, the television can only be controlled by a single viewer. Thus, in a room full of viewers, a remote control or other device that is configured to control the television must be passed around the room from viewer to viewer if different viewers desire to control the television (and the associated displayed content). Also, difficulties are often encountered when trying to find or select web-based video content. For example, a television might be configured to implement a simple web-browser which allows the user to find websites and then use the existing website interfaces to search for content (such as by using existing menus, search bars and the like of such websites to search for content). However, use of such an existing web-server provided interface to search for content can be cumbersome and time consuming to use. In a group of viewers, it might thus take a single viewer a great deal of time to search for and locate desired web-based video content for display on the television, all while the other viewers sit and wait. Moreover, apps that are initiated on these smart TVs are consumer apps which are tied into consumer accounts with different licensing than what is needed for commercial viewing.

Similarly, watching sports at bars and restaurants has largely remained the same for the past few decades. Typically, the operator of the bar or restaurant selects the content (such as the particular programs) that they wish to have displayed on the televisions. This involves finding a remote control and then selecting a channel from a guide on the TV, which often takes time and is frustrating given the limitations of on-TV channel selection interfaces. Some operators have a “cheat sheet” on which they list popular sports channels, but with the growing number of channels displaying sports events, that cheat sheet may become almost as complicated as the main guide. The patrons then generally end up having to watch whatever program is being displayed on the television which is closest to them in the bar or restaurant, whether it is something they wish to watch or not.

As noted above, these content display systems, such as those used to present programs at bars and restaurants, are also limited in the content which can be displayed, such as to traditional over the air, cable, or satellite provided programming. Recently, fantasy sports and sports betting has increased become an integral part of the sports fan experience. Fans regularly use their smartphones to keep track of the fantasy teams' performance and sports bet performance. Fantasy sports has increased in popularity, especially through the introduction of daily fantasy sports through providers like Draft Kings and Fan Duel. In the U.S., the Professional and Amateur Sports Protection Act of 1992, which rendered sports betting legal in most states, was repealed in 2018 by the U.S. Supreme Court, enabling all states to legalize sports betting. Already many states have or are in the process of enacting enabling sports wagering legislation, notably New Jersey, where players can set up accounts and bet on their smartphones from any location within the state.

Also, online websites have emerged as a complementary content source to the traditional means of following sports teams, players and statistics. Traditionally, the information about a sports team would be found in newspapers (e.g. LA Times), magazines (e.g. Sports Illustrated), and TV (e.g. ESPN). Now, websites like Bleacher Report are hubs of information and fan engagement, including videos and podcasts that provide in-depth commentary on teams and players. Fantasy sports and sports gambling have their own websites, with accompanying articles, statistics, projections, video and podcasts. These can be generalized per sport or specified per team.

While the sources and type-and-kind of information have expanded, the ability for fans to access this content in group environments has been limited. Fans check stats on their personal smartphones. However, it is difficult if not impossible to check stats and analytics at the same time as entering a fantasy sports lineup or placing a sports bet. Therefore, the players need to flip back-and-forth between apps or web browser tabs to get the information that they use to enter contests or place bets. If at their home, workplace or someone's living room, they may bring their laptop or tablet to access additional content on their second screen. These larger devices are clunky and difficult to manage in retail venues like sports bars. There is also the risk of spillage on the devices, which often occurs at sports bars. But there is no easy way to share the information on larger TV screens that can be viewed by multiple people. Moreover, people are constantly looking back-and-forth between their smartphones, tablets or laptops and the larger TV screen in the room.

It has been found that people, especially in groups, prefer watching content on the largest screen available. A better way to share the personalized content they see on their screens onto the group screens is desired.

Also, listening to TV audio in a shared environment is similarly complicated. If there is more than one TV active, then guests are often watching one TV, but listening to the content of one or more additional TVs. If the audio is active on multiple TVs, guests are subject to multiple audio signals, e.g. “audio conflicts”, degrading their experience.

Changing which audio is active is complicated in such settings, however. For example, this may require multiple TV controllers or physically approaching multiple TVs to press their audio control buttons. If the shared environment is a retail venue like sports bar, operated by a manager, bartender and/or servers, then the guest must ask one of the staff members for help. That staff member may or may not be trained or authorized to adjust the audio outputs.

If the correctly authorized staff member receives the guest request, the staff must: 1) Be trained to adjust the audio output successfully; 2) Use one or more device, including remotes and buttons on TVs, to change the audio output(s); 3) Juggle the interests of existing guests and new guests; and 4) Ensure the volume of the resulting audio output is adjusted to the right level for the target guests, while not being disturbing for the surrounding guests.

An improved system and method for controlling the distribution and presentation of data, visual and/or audio content is desired.

### SUMMARY OF THE INVENTION

Embodiments of the invention comprise a media distribution system, and most preferably, a system for controlling the distribution and presentation of remotely sourced data, visual and/or audio content by one or more video displays and/or associated sound generating devices, by one or more users.

In one embodiment of the invention, a media control device receives inputs, such as content selections, from a plurality of user devices. Users may download a control application to their user device, such as their portable communication device such as a phone, laptop or tablet or access a similar web-based application through a web interface such as a web browser in order to provide the control instructions.

The application at the user device or a browser, alone or in communication with the media control device or another device, causes the display of an application interface for displaying information to the user via which the user is presented information and can provide inputs. The application interface facilitates the user's selection of remotely sourced content. Such content may comprise, web-based content from one or more third party web servers, such as streaming video content, or content from other sources, such as a cable or satellite feed.

In one embodiment of the system, the system is distributed and scalable. The media control device may comprise a cloud server. The users communicate with the media control device via the Internet. The media control device then sends control instructions to individual display controllers which are each associated with a different video display. Those display controllers may then fetch, such as over the Internet or other devices such as a cable or satellite decoder box, desired content from the third party web servers or other sources for display on their associated video display. In this configuration, media control device control each display controller, including associating users and their selected content, with those display controllers and the associated video displays.

In another embodiment of the system, the system is centralized. The media control device may comprise a local server which receives, such as via Bluetooth, inputs from the user devices. The media control device may then fetch desired content from the third party web servers and then distributes (such as via a hub), the different content to the different video displays (whereby the video displays may again display different content selected by different users).

In all cases, the media control device is configured to allow an operator to control which users can cause content to be presented on a video display or cause user-selected content selected by different users to be displayed on different video displays, and/or charge a rental or use fee for the use of the device.

In one embodiment, audio conflicts are resolved through a method of selecting audio presentation devices and/or a system of prioritization. The system may cause audio content to be presented by speakers of a designated display or speakers associated therewith, or based upon potential audio conflicts or prioritized purchasing, may direct the audio content to a user's device, headphones or a local sound generating device.

In one embodiment, a user may not only select primary content for presentation via a display, but may select secondary or additional content for presentation. The primary content might comprise, for example, a sports event program or a visualization of the sports event. The secondary content might comprise wagering information, sports betting information, statistics or the like. The secondary content may be personalized based on the user's account information and settings. The secondary content may be display as a chyron to the primary content. In similar fashion to secondary content, tertiary or additional content can be displayed.

The invention has particular utility to bars, restaurants and the like where there are multiple patrons and the operator desires to allow the patrons to control the presentation of data, visual and/or audio content on one or more video displays and via audio presentation device in the establishment.

The system may include various additional features, such as the ability of the operator to interject advertising or other secondary content which is then displayed with the user selected content, to require the user to pay for the ability to select content, and to filter or control the content (such as by blocking undesirable content).

As another aspect of the invention, user payment for the display selection service may be processed via the system. In addition, the system may be configured to transmit or process wagers, such for bets upon a displayed sports event.

A user may have a user account. The user account may include information regarding the user which is stored, such as at the media control device or in association therewith. A user might also associate secondary account information or other information with the account, such as financial payment/account information, information regarding a user's social media account(s), etc. In such a configuration, displayed secondary content may comprise materials from the user's social media account or the like, such as photographs.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a system of the invention;

FIG. 2 illustrates additional details of the system which is illustrated in FIG. 1; and

FIG. 3 illustrates aspects of a method of controlling the presentation of remotely sourced content via the system illustrated in FIG. 1;

FIG. 4 illustrates another embodiment of a system of the invention;

FIG. 5 illustrates aspects of a method of controlling the presentation of remotely sourced content via the system illustrated in FIG. 4;

FIG. 6 illustrates another embodiment of a system of the invention; and

FIG. 7 illustrates particular details of yet another embodiment of a system of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

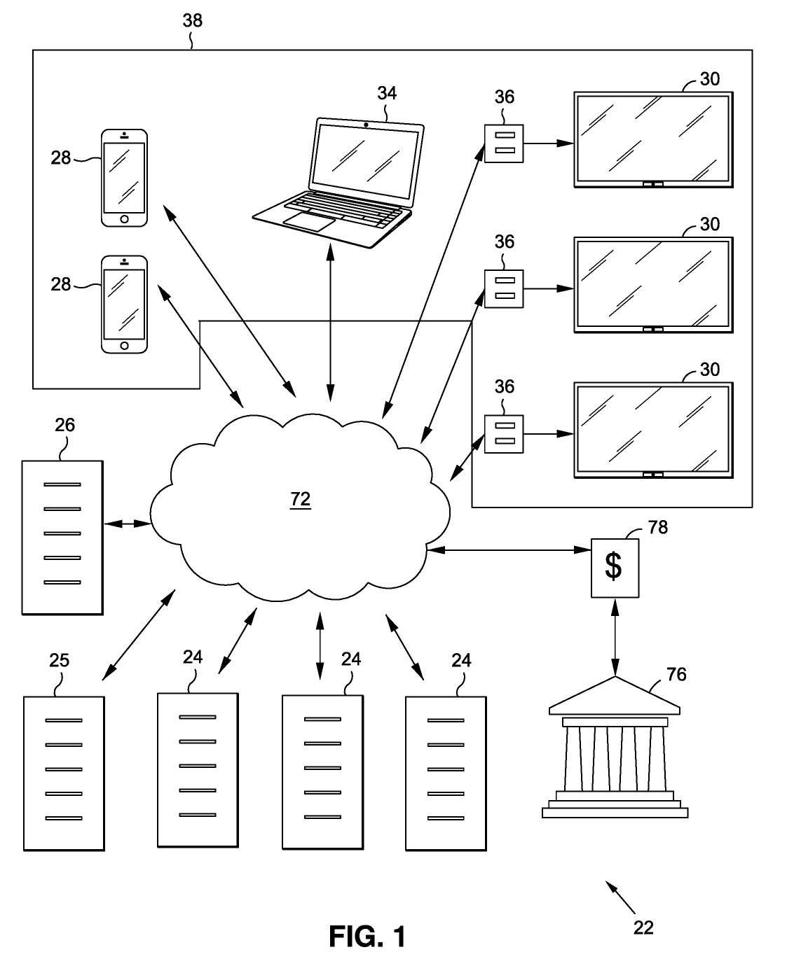

FIG. 1 illustrates one embodiment of a system 22 of the invention. In one embodiment, the system 22 comprises a media distribution system, and most preferably, a system for controlling the distribution and presentation of remotely sourced data, visual and/or audio content.

In general, as illustrated in FIG. 1, the system 22 may comprise a media control device 26. The media control device 26 is configured to, under the control of or based upon input from one or more user devices 28,34, control the presentation of content at one or more video displays 30 via associated display controllers 36 and/or to control the presentation of audio at one or more sound generating devices 103. In general, the media control device 26 receives control instructions from one or more user devices 28,34, and sends instructions to the display controllers 36 which cause them to access remotely sourced content based upon those instructions, such web content via one or more content webservers 24,25 and then generates an output which causes the one or more video displays 30 and/or sound-generating devices 103 to display or present the desired content.

In one embodiment, the content webservers 24 or content supplier platforms might comprise, for example, Twitch®, YouTube® or other web-based media platforms via which web-based media may be accessed. Each of these webservers 24 or media platforms might comprise one or more devices, such as a collection of linked devices. As one example, these webservers 24 may be capable of receiving user-supplied content or information (such as videos taken by users), storing such user information, and allowing access to that information. Such third-party content-providing webservers 24 or platforms are generally well known. As disclosed below, however, the remotely sourced content might comprise other sources of content (such as more traditional cable or satellite delivered content) and may comprise user-specific content, such as a user's sports betting information, fantasy sports wagering information or the like.

In one example implementation of the invention, aspects of the system 22 may be implemented relative to one or more retail establishments or other locations 40. Such an establishment 40 might comprise, but is not limited to, a bar or tavern, a restaurant, a casino, etc. The establishment 40 may have a plurality of video displays 30. A plurality of customers or patrons may patronize the establishment 40, wherein the customers each have a customer user device 28. In one embodiment, an operator of the establishment 40 may utilize an operator user device 34 relative to aspects of controlling presentation of content on the video displays 30.

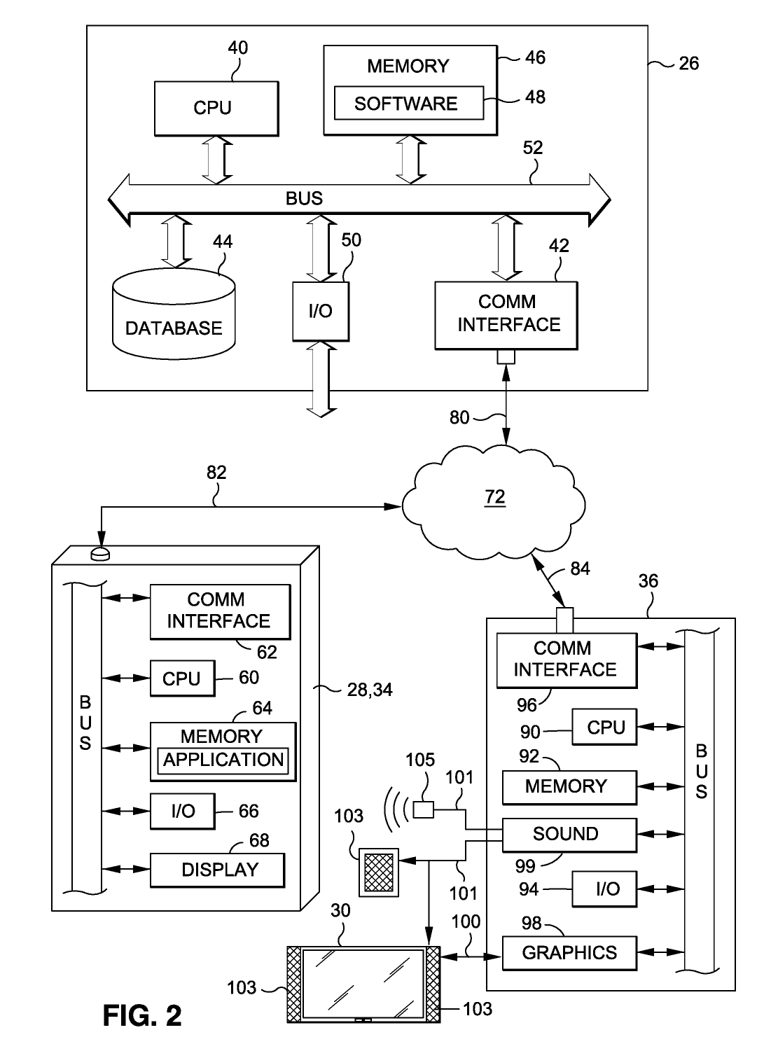

Additional details of the system 22 will be described with reference to FIGS. 1 and 2. In one preferred embodiment, the media control device 26 may comprise one or more cloud-based servers. As one example, the media control device 26 may comprise one or more processors or controllers 40, at least one communication device or interface 42, a database 44 or other data storage device, and one or more additional memory or data storage devices 46 (such as separate from the database 44). In one or more embodiments, the processor(s) 40 is configured to execute one or more instructions, such as in the form of machine readable code 48 (i.e. “software”), to allow the media control device 26 to perform the functions herein. The software 48 is preferably non-transitory, such as by being fixed in a tangible medium. For example, the software 48 may be stored in the one or more memory devices 46. One or more of the memory devices 46 may be read-only. In addition, the software may be stored on a removable medium in some embodiments. In general, the one or more memory devices 46 are used as temporary storage. For example, the one or more memory devices 46 may be random access memory or cache memory used to temporarily store some user information and/or instructions for execution by the at least one processor 40.

The software may comprise one or more modules or blocks of machine readable code. Each module may be configured to implement particular functionality when executed by the one or more processors 40, and the various modules may work together to provide overall integrated functionality. Of course, in certain embodiments, it is also possible for various of the functionality to be implemented as hardware, i.e. a processor or chip which is particularly designed to implement various of the functionality described herein.

In one embodiment, the media control device 26 may include (or be linked communicatively at one or more times to) one or more input and/or output devices 50, such as a keyboard, mouse, touchscreen, video display or the like, whereby the processor 40 may receive information from a servicer of the media control device 26 and/or output information thereto. This allows, for example, a servicer of the media control device 26 to interface with the media control device 26 to upgrade, maintain, monitor, etc., it. In other embodiments, a servicer might interface with the media control device 26 via a separate workstation or other device.

In one embodiment, the processor 40 and other elements of the media control device 26 may be linked and thus communicate over one or more communication buses 52. In this manner, for example, the processor 40 may read/receive software from the memory 46 for execution, receive inputs and provide outputs to the various I/O devices 50, receive information from or output information to external devices via the communication interface 42, etc.

The one or more communication devices or interfaces 42 permit the media control device 26 to communicate with external devices, networks, systems and the like. As one example, as illustrated in FIG. 1, the media control device 26 may communicate with one or more user devices 28,34, the display controllers 36 and the like.

As illustrated in FIG. 2, the user devices might comprise, for example, computing or communication devices. In a preferred embodiment, the user devices 28,34 are portable communication devices such as a laptop computer, a tablet, a smart phone/PDA or the like. The user devices 28,34 are preferably general purpose devices, but they could be special purpose or specially adapted devices. As illustrated in FIG. 2, in one embodiment the user devices 28,34 may comprise a controller or processor 60, a communication interface 62, a memory device 64 (such as for storing machine readable code or “software” for execution by the processor 60, such as in the form of a downloaded software application), an input/output interface 66 (such as for receiving input from a touch-screen, one or more buttons or the device or the like), and at least one video display 68. Preferably, the user devices 28,34 are capable of receiving user input, transmitting data and receiving data (such as via a communication interface), and displaying information or data, such as via their associated video displays. As indicated above, in one example implementation, customers or patrons of an establishment might use user devices 28 in the form of their own smart phones/PDAs or the like, while an operator might use a user device 34 in the form of a laptop or tablet or the like which is located in the establishment. However, as noted, the user devices may have various forms.

As also illustrated in FIG. 2, the display controllers 36 preferably comprise computing-type devices. The display controllers 36 may thus comprise a controller or processor 90, a memory device 92 (such as for storing machine readable code or “software” for execution by the processor 90, such as in the form of a pre-installed or downloaded application), one or more input/output interfaces or devices 94, a communication interface 96, a graphics controller 98, and an audio or sound processor 99. These various devices may communicate with one another, such as via a bus.

In one embodiment, the graphics controller 98 is configured to process web-based graphics data (such as HTLM5 data) and output it a video display compatible format, such as HDMI video data which is output via an HDMI output 100 to an associated video display 30. The audio or sound processor 99 is preferably configured to generate an audio output 101 (which may comprise an analog or digital output). This output 101 may be provided to the display 30 (and any associated sound processor thereof) for output to one or more sound-generating devices such as one or more speakers 103 of the display 30, or for output to one or more separate speakers (or other audio generating devices or associated audio systems). In one embodiment, the audio output may be transmitted to one or more devices, such as a user device 28,34, via a wireless transmitter 105.

In a preferred embodiment, a display controller 36 is provided relative to each video display 30. The video displays 30 may comprise any variety of now known or later developed video display devices. Such may comprise, for example, DLP, LED, OLED, LCD, CRT or other video presentation or projection devices which are configured to, in response to a video input, generate or provide a video output. Such displays 30 might, for example, be located on the walls, at booths or tables or in other locations, such as in an establishment 40 as described above. As indicated, the video displays 30 may include associated audio generating devices, such as speakers 103, and/or one or more separate audio systems may be provided (including separate speakers 103 and/or other audio devices such as amplifiers and the like).

The communication interface 42 of the media control device 26, the communication interface 62 of the user device 28,34, and the communication interface 96 of the display controller 36 each preferably allow those devices to send and/or receive data or information over communication links 80,82,84 with those devices. Those communication links may be dedicated communication links or be part of WANs, LANS, public or private networks, the Internet, cellular telephone networks or the like, wherein the links or portions thereof may be wired and/or wireless, and the communication interface and associated links may support communications in various protocols. In a preferred embodiment, the media control device 26, user devices 28,34 and the display controllers 34 are all configured as Internet-enabled devices which can communicate via one or more communications links or paths which includes the Internet 72, such as via a TPC/IP protocol or other protocols, relative to data in various formats. In other embodiments, the display controller 36 may also include an interface for receiving other content, such as an NTSC or PAL signal or other video input (component, composite, HDMI, DVI, etc.), such as for receiving an over-the-air, cable or satellite signal.

As noted above, in one embodiment various functionality of the system 22 is implemented relative to the above-described hardware via software. In one embodiment, various functionality is implemented via software 48 which is associated with the media control device 26 (such as stored in the memory 46 thereof and executed by the processor 40), via software associated with the user device 38,34, and via software associated with the display controller 36. In one embodiment, the software which is associated with the user device 28,34 comprises a downloadable application. As one example, a user of the user device 28,34 may download the software via the Internet, such as from the media control device 26 or another location, for installation and then execution on their device. In one embodiment, the software could similarly be downloaded to the display controllers 36. In other embodiments, the display controllers 36 might be configured as “plug and play” devices where the software is either preloaded or software is associated with the controllers 36 which causes them to fetch the remaining software. In such a configuration, the operator might simply power up the display controller 36, link it to the Internet 72, and then the controller 76 might automatically configure itself.

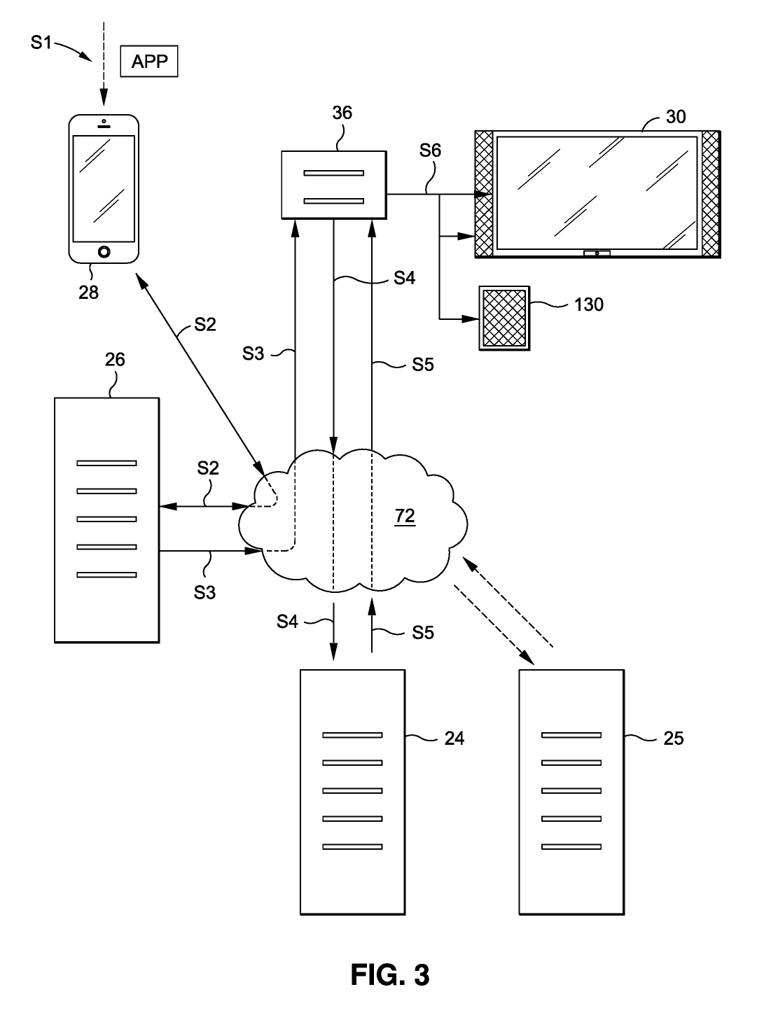

Aspects of use/operation of the system 22 will now be described with reference to FIGS. 1 to 3. In one embodiment, a user downloads or installs a media control application on their user device 28, as at Si in FIG. 3. For example, the user might use a browser on their user device 28 to access a server which allows the user to download the application.

Once the application has been downloaded, the user may execute the application. This may cause, for example, their user device 28 to display a graphical user interface. In one embodiment, the graphical user interface displays information to the user and allows the user to provide input. Preferably, the graphical user interface facilitates the user's location and selection of remotely sourced content, such as desired web-based content, such as an audio-visual feed or content, to be displayed by one or more of the video displays 30 of the system 22. It is noted that instead of downloading and installing an application which is executed by the processor of the user's device 28, in equivalent format the user might access a web-based application which is implemented by a remote webserver, such as the media control device 26, such as via a web browser or the like on the user's device 28.

In one embodiment, when the user provides inputs to their user device 28 via the application (or to the web-based application via their browser) (see step S2 in FIG. 3), one or more of those inputs are preferably transmitted to the media control device 26, such as over the Internet 72. Software running at the media control device 26 is configured to receive and process those inputs. As noted, for example, the user might select desired content from a particular webserver. The media control device 26 processes the user requests and then generates and outputs, such as at step S3, control instructions for one or more of the display controllers 36.

The one or more display controllers 36 process those instructions. As one example, the instructions might cause a display controller 36 to seek information from a designated content webserver 24, such as at step S4. In response, the webserver 24 preferably transmits the desired content, such as by transmitting it over the Internet 72 to that display controller 36, such as at step S5.

The display controller 36 then preferably processes the content. In one embodiment, this may comprise turning the web-based content (such as HTML video) into other forms or formats, such as an HDMI video format or the like. This output is then transmitted by the display controller 36 to its associated video displays 30, such as at step S6 in FIG. 3. As described in more detail below, any associated audio may be presented via the speaker(s) 103 associated with the display 30, or via a separate audio presentation device 103 such as a separate sound system, the user's device 28,34 or the like.

FIG. 3 focuses on a single user, such as a single customer, and how they may control content which is display via at least one video display 30. Most importantly, in accordance with the invention, a single user might control the display of content on multiple video displays 30 and/or multiple users might each control the display of content on different video displays 30. Further, user control of displayed content is supervisor controlled, such as via the operator via their user device 34.

As one example, a patron or customer of an establishment may download a control application to their device (or accessible as a web-based application, such as through a web browser). Subject to the establishment operator's control, the patron may be allowed to make content selections, control content to certain video displays 30 and the like.

In one embodiment of the invention, each user who communicates with the media control device may be uniquely identified. This may allow, for example, the operator select the particular patron who they wish to allow to make content selection, or allow the operator to associate particular patrons with particular video displays. As one example, Patron 1 and Patron 2 may visit a bar having a Video Display 1 and Video Display 2. Both patrons may install and initiate their media control applications. The operator may then select Patron 1 and associate them with Video Display 1 via an interface to the media control device 26. The media control device 26 processes these instructions, thus permitting Patron 1 to make a selection of desired content (e.g. Patron 1 provides inputs to their user device 28, which inputs are relayed to the media control device 26 for processing, as described above). In this configuration, the operator is able to control when a user is permitted to cause information to be displayed via a video display (which may comprise a designated one of the video displays or more than one, such as all of the video displays), and wherein the operator can link different users to different video displays. As a variant of the example above, the operator might provide input to the media control device 26 via their user device 34 which allows Patron 1 to control the content which is displayed by Video Display 1 and which allows Patron 2 to control the content which is displayed by Video Display 2.

In one embodiment, the operator may utilize various content controls in order to control the content which can be displayed via the video displays. These controls may allow the operator to limit the content which is displayed or select the content which is displayed, without guest control (or may control the content which is displayed directly to cause content selected by a guest to be displayed even though the guest is not controlling the display), at one or more times.

In one embodiment, the operator control features may be implemented via the application at their user device 34 communicating with the media control device 26. This application might, for example, have user login configurations which allow different users to access different control features. The control features might, for example, be displayed relative to one or more graphical user interfaces which include displayed menus and other information. For example, such interfaces might display information about customers who are connected to the system or are “active”, the particular video displays and the linking between customers and displays, and may include the various content controls. In one embodiment, the media control device 26 might include a baseline set of content controls. The operator might be permitted to change those (making them more liberal or less liberal), relative to the content which may be displayed by a particular display or all displays. For example, the media control device 26 might include content filters, a list of blocked websites or the like. This information may be used, for example, to restrict the content which a particular user can selected and/or which the video displays 30 can display. For example, the content control information might include a list of blocked websites, such as XYZ.com. If a user were to try and select content from that website, the media control device 26 might block those instructions and cause the user's device to display a message that the selected content is not allowed.

In this same vein, instead of blocking or limiting content, the media control device 26 might simply indicate to users what sources or content can be displayed (such as modified by the operator). For example, the operator of a sports bar might only want customers to be able to display sports-related information on the video displays 30. When customers of that bar link to the media control device 26, the media control device 26 may cause the displays of the customer devices to only display content which the user can select from.

Additionally, in one embodiment, the system 22 may be configured to “short cut” or simplify the access to content provided by a webserver 24. For example, the graphical user interface of the user's device 28 might present buttons which allow the user to select content from “YouTube”, “Twitch” or other designated content providers. As one example, upon selecting “Twitch”, the graphical user interface may display a completely new interface which is configured to allow the user to easily search for and/or select content from the Twitch website. Preferably, this interface is different than the one which the user would see if they directly accessed the Twitch website, and instead serves as an intermediary with that website, such as by simplifying, aggregating, translating information, etc. For example, instead of being presented with “Featured Games” as occurs when a user directly accesses the Twitch website, the user of the user device 28 might be presented with a menu, such as via which they may select game genres (upon which, the application may cause the user device to, via the medial control device 26, contact the Twitch server and cause a search for games having the designated genre to be conducted, with the results being presented back to the user).

As noted above, one embodiment of the invention is an audio distribution or presentation control feature. In one embodiment, the media control device 26 is configured to control the presentation of audio content, such as audio content which is associated with user-selected video content. The media control device 26 may control the presentation of the audio content based upon input from the user and/or secondary factors, such as audio content which is being presented to other users and potential audio conflicts which might result therefrom.

In particular, in one embodiment, the media control device 26 is configured to determine the availability of sound generating devices and then prioritize the presentation via those devices and/or present sound generating options to the user. First, the media control device 26 may allow user-selected audio content to be presented via speakers 130 which are associated with or which are located close to the video display 30 which is presenting associated video content (which may be referred to as “primary” sound or audio generating devices). In one embodiment, this option may only be presented to a user if they have paid for that option, as detailed below. In another embodiment, this option may only be presented if another user has not already elected to have audio content distributed by nearby audio generating devices (which would then result in audio conflict or overlap if the user's content was then also distributed via nearby devices). In such event, the media control device 26 may cause the audio to be distributed by one or more secondary audio presentation devices—either automatically or based upon user selection of one of a designed number of audio presentation devices. For example, the media control device 26 might present the options of having the audio presented via a speaker located at the user's table (such as a wireless speaker), via the user's device 28,34, via headphones, or other “personal” audio generating devices. The user might then select one of those devices. The media control device 26 may then cause the audio to be routed to the selected device, such as via the display controller 36 which is distributing the associated selected video content (which audio content may, as noted above, be transmitted wirelessly to the selected device) or directly from the media control device 26 to the selected device (such as via the network 72).

In another embodiment of the invention, the system 22 may be configured to allow a user to display secondary content in association with primary content. The primary content may comprise, for example, web-based content or content from other sources. For example, the primary content might comprise programming via over-the-air, cable or satellite sources.

The secondary content may also vary. In a preferred embodiment, the secondary content is a user's content, such a user wagering information, fantasy sports information or other information which is associated with the user. Of course, the additional content might comprise more than just secondary content, such as secondary and tertiary content, such as content from a primary source and at least one additional source (such as two or more additional sources).

This content may, as illustrated in FIG. 1, be provided by a webserver 25. As one example, a user may have a wagering account or fantasy sports account with a provider. The provider may maintain the user's account and associated information on or in association with a web server 25. The user's account information may comprise, for example, information regarding a user's fantasy sports team, fantasy sport picks, wagers or the like. Such a provider may also generate information regarding the user, such as the user's current fantasy sports standings, certain fantasy sports statistics, the status or outcome of wagers, and the like.

In one embodiment, the user may elect to have such secondary content displayed in association with primary content. For example, the user may select, as described above, primary content. This content might comprise, for example, a sports event. In addition, the user may elect to have secondary content for displayed with that primary content. As with the primary content, the secondary content might be selected by the user from secondary content options or might be turned on or off. As one example, the user might link one or more of their wagering accounts. The media control device 26 may then cause the user's device to display options such as a menu: 1) Present information from XYZ account or 2) Present information from ABC account or 3) Present both.

In one embodiment, the user may provide account information (such as account login information such as one or more of an account number, user ID, user password, etc.) when a selection is made, or such information may be stored. That information may be used to access the selected secondary content. As one example, as illustrated in FIG. 3, information regarding selected primary and secondary content may be received by the media control device 26 and be transmitted to a designated display controller 36. The display controller 36 may then send a request for primary content to a primary content source, such as first webserver 24, and a request for secondary content to a secondary content source, such as a second webserver 25. In one embodiment, information regarding a user's wagering account, social media account or the like might be linked to a user's media control account or their application. In this manner, when the user views the graphical interface on their user device 28, they may see options regarding primary content which may be selected, as well as information from their linked wagering account, social media account(s) or the like which may also be selected for presentation.

In one embodiment, the display controller 36 then causes the primary and secondary content to be displayed by the associated video display 30. In one embodiment, the secondary content is preferably displayed as a chyron, such as at a portion of the top or bottom of the display. In one embodiment, the display controller 36 may, for example, include a scaler and a video combiner. The display controller 36 may then scale the size of the primary content to accommodate the chyron, scale the secondary content to fit the chyron, and the combine the content for display on the display 30.

As noted above, the secondary content might comprise other types of content, and more than primary and secondary content might be displayed, such as primary, secondary and tertiary content. As one example, the secondary and/or tertiary content might comprise social media, photographs and the like. For example, a user might select primary content for display and then also login to their social media account to cause some of their social media information to be display, such as recent photos, Tweets or the like. As another example, the primary content might comprise a live sport feed, the secondary content might comprise real-time statistical information obtained from a secondary source, and the tertiary information might comprise, as discussed in more detail below, betting information from yet another source.

It will be appreciated that the display controller 36 may have various configurations. In one embodiment, the display controller 36 is a single board computer having a small form factor, such as a Tinker Board™ by ASUS (www.ASUS.com), as programmed to include the functionality described herein. In other embodiments, however, the display controller might comprise other types of devices. For example, an Amazon Fire TV Stick™ might be modified to provide the functionality herein, such as by downloading an application to the Fire TV Stick™ which enables it to perform the functionality (for example, an application may be downloaded to such a device, which application allows the media control device's 26 instructions to cause the device to contact the first and second webservers 24,25, etc., to seek the desired content, to combine that content and cause it to be displayed on the associated display, etc.).

In yet another embodiment, the functionality may be implemented relative to a TV which includes a display controller type device, such as a controller which includes a built-in web browser. In such a configuration, an application such as that described above might be downloaded to the controller of the TV. In another embodiment, the web browser of the TV or associated device might be pointed to a particular web address, such as an address of the media control device 26 (such as via input of that address to the web browser of the TV). When the TV's web browser contacts that web address, the web server associated with that address may be configured to provide redirect instructions to the web browser to the first and second webservers 24,25, etc., whereby the web server of the TV is essentially routed to those servers to obtain the selected content (in one embodiment, it is possible that the media control device 26 might actually locate the desired content and combine it and then, when contacted by the TV' s web browser, provide that feed to the TV or other display).

Various advantages and other features of the invention will now be described. One aspect of the invention is a specialized system, including a user device application, a media control device and one or more display controllers, which allows a user to control the distribution and presentation of remotely sourced content, such as data, video or other steaming media, to be presented on or more video displays which are separate from the user's device. Moreover, the system allows multiple users who are using different user devices to control the display of web-based content at one or more video displays.

The invention has particular utility to public or semi-public/commercial environments. For example, a bar may have a plurality of video displays. Currently, content may be provided to those displays via one or more dedicated media distribution networks, such as a cable or satellite distribution network. In accordance with such a system, a bartender or the like might use a remote control to control the cable or satellite distribution box to change the content which is displayed. However, this configuration does not allow the bar to access or display web-based media, nor does such a system conveniently allow a patron of the bar to select the desired content to be displayed.

In one embodiment, the provisioning of patron or user control may be conditioned, such as upon payment by the patron, based upon a purchase, by use of points, based upon a promotion or various other criteria. Payment might be effectuated in various manners. For example, a user might be required to enter payment information (such as PayPal® or credit card account information) which is used to pay for the user's right to control the displayed content. In other embodiments, the user might be required to set up or link such an account to their application (whereby the financial payment information does not need to be manually entered each time), or the user might be required to have an account with the operator. In one embodiment, as illustrated in FIG. 1, when payment is required, the media control device 26 may be configured to contact one or more external payment processing servers or systems 78 in order to affect the payment, such as from a user's bank 76.

As one example, a bar might indicate to a user that they can control the presentation of content at a main bar video display for 1 hour based upon a $5 payment. Based the user's PayPal information, when the user confirms their selection of content or upon other confirmatory events, the media content device may contact the PayPal servers and request payment for $5 based upon the user's PayPal account information (upon which PayPal back end processes this payment, such as by communicating with the user's bank using stored bank account information to affect a transfer of funds or payment from the user's bank to the bar operator's bank account). Of course, a wide variety of payment methods might be utilized.

In a similar fashion, presentation of audio content, such prioritization thereof, may be dependent upon payment. As noted above, the system may be configured to prevent the presentation of audio content from closely located video displays which are displaying different content (such as selected by two different users). In one embodiment, so long as an audio conflict is not determined, two user's selected audio content may be presented, such as via the speakers associated with their selected displays.

In one embodiment, however, at all times, or at least in the situations where a potential audio conflict is determined, a user may be required to pay a premium to have their selected audio content (such as associated with their selected video content) be presented at their selected display or closely associated audio generating devices. In such a configuration, users who elect to have content displayed on closely located displays 30 will be blocked from having the associated audio content from being presented by those displays 30 or closely associated audio presentation devices. Instead, those other users may only be presented with options to have their selected audio content to be presented by a “personal” audio device (or one which is not likely to present audio conflicts), such as their user device 28,34, headphones, a speaker at their table or the like.

In one embodiment, a premium payment may entitle a user to have their audio content presented by the primary associated audio device associated with the display 30 so long as their selected video is being presented (such as the duration of a selected sports event or the like), or for a designated period of time (30 minutes, 1 hour, etc.).

It will be appreciated that the system, and particularly the media control device 26 may be programmed with information which is specific to a particular location regarding the video displays and audio generating devices, such as which devices are located in close proximity thereto for use in determining potential audio conflicts and the like. For example, this information may comprise information that a Display 1 and Display 2 (and their associated audio presentation devices) are in close proximity, but that Display 1 and Display 3 are not in close proximity.

As noted, the system of the invention may be used to control the distribution and presentation of a variety of remotely sourced content, such as web-based third party content. This content preferably comprises video, but may comprise other types of information. As one example, the content may comprise videos which are accessible via the YouTube® website or video game content or information, such as via the Twitch® website. As noted herein, however, aspects of the invention may apply to other remotely sourced content such as over-the-air, cable or satellite distributed content, among others.

In accordance with the invention, a technical solution provides bars, restaurants and similar venues with a convenient system for displaying web-based content to patrons. More importantly, these venues are provided with a convenient way to allow their patrons to select and control the displayed web-based content. At the same time, however, the operator retains complete control over the video displays. For example, the operator can block certain users from controlling the display of information or content on the displays or could completely control what content is displayed on the displays. As one example, the operator might control the content which is displayed on the displays during a peak business time, such as on Saturday night, but allow users to control the content which is displayed on the displays on a Monday night.

In one embodiment, the software or the application which allows the operator (such as a bar owner, etc.) to: 1) limit or control the presentation of remotely sourced content, and particularly web-based content; 2) control which patrons or users get to select content for presentation; 3) address/resolve potential audio conflicts; and 4) optionally charge payment or impose other criteria for the right to control the presentation of the content.

First, the media control device application may permit the operator to control the displayed content. For example, this application may include filters which the operator can set, such as to block particular websites or undesirable content from being selected and displayed by a user, such as adult content, offensive content, etc. In one embodiment, these selections might cause the user's device to display different or limited information.

Second, although multiple patrons or users may interface with the media control device via their user devices, the operator may control which user(s) can control the device. As indicated, users might be identified by unique IDs, by user names or the like. In one embodiment, a user might be required to create an account with the operator and a user ID might be tied to their account. When a user links to the media control device, they might be required to provide their user ID (and, optionally, a password). The operator might see a list of the IDs of users who are linked to the media control device and then have control options, such as to “allow user control” as to a certain user, “designate video display” such as to link a user to a particular video display, “block user” or the like.

In one embodiment, as noted herein, the operator might allow a user to control the presentation of content for free, or based upon particular criteria. These criteria might be the purchase of goods or services, payment of points or loyalty rewards (which might be associated with a user's account), and/or monetary value payment (thus serving as an additional revenue source for the operator).

The system might include other features as well. As noted above, the system may be configured to present at least secondary content (such as secondary and tertiary content) in addition to primary content. In one embodiment, the secondary content may be a user's information for display with their selected primary content. However, this feature may also allow an operator to custom-configure and display advertising or other information. For example, such information might be stored in the database 44 associated with the media control device 26. The operator might set various parameters or settings which define when advertising, certain ads or the like are to be displayed. This information may be provided by the media control device 26 to the display controllers 36. When the display controllers 36 are processing content, then may fetch the advertising content and overlay it onto or insert it into the content for display by the video displays 30.

As another aspect of the system, an operator may track displayed content, user use and the like. This information may be captured by the media control device and then provided to the operator, such as in report form or the like. This information might comprise, but is not limited to: 1) how many different users have downloaded the application; 2) how many users have attempted to link their device to the media control device; 3) the amount of time certain users have controlled the display of content; 4) information regarding the different content which has been displayed by users, etc.

In one embodiment, the system may include a user-location confirmation feature. This feature may be used to ensure that a user who seeks to control the display content is at the venue and not remote from the venue. For example, the application on the user device 28 might be configured to gather GPS or other location identification information and transmit that information to the media control device 26 when a user seeks to control displayed content. The media control device 26 may use the GPS information to confirm that the user is located at the venue where the user seeks to control the displayed content. Of course, other means may be used to verify the location of the user or restrict the ability of the user to control the display of information to solely when the user is located at the venue.

It will also be appreciated that the downloadable application or web-based graphical interface might be “generic” and thus allow a user to control the display of information at different venues in different locations. In such a configuration, geographic location information may be used to associate the user with a location. In other embodiments, the application might be specific to a particular venue (for example, the user might have to download a specific application in order to control the display of information at “Jimmy's Bar” and then have to download a separate application to control the display of information at another location, like “Joe's Restaurant.”

As another aspect of the invention, the system of the invention may permit or facilitate wagering. In the event the operator of the system may legally offer or process wagers (such as, where applicable, by being licensed), the user may place wagers. The wagers may, for example, comprise sports wagers, fantasy sports wagers or the like. In one embodiment, a user may set up an account with the system operator. The user may utilize this account to pay for premium services such as those noted above, and/or to place wagers. In such a configuration, a user may provide funds for wagering which are associated with their account or the user may otherwise provide payment, such as via bank or credit card, funds transfer, etc. In one embodiment, information regarding the user's wagers may, as noted above, be presented in the chyron associated with a user's selected primary content.

In another embodiment, the user may link to a secondary wagering entity to place wagers. As noted above, a secondary wagering entity may operate a webserver 25 via which the user may place wagers or the like. The user may use their user device to place wagers via such an entity and, as noted above, have information regarding those wagers or the like, be presented as displayed secondary content.

In one embodiment, displayed secondary content may be custom-configured for presentation, such as based upon displayed primary content, or based upon other criteria. For example, a user may select primary content comprising a sports event between Team A and Team B. The user may also have various wagers associated with that event. As the event progresses, a variety of secondary content may be displayed to the user, such as the outcome of various of their wagers, the current status of unresolved wagers, and the like. As one example, a user might have a fantasy sports team which includes Players A, D and F which are on Team A. The secondary content might comprise information regarding those particular players (such as various associated stats such as rushing yards, points scored, passing yards or the like), but not other players who are playing in the selected game.

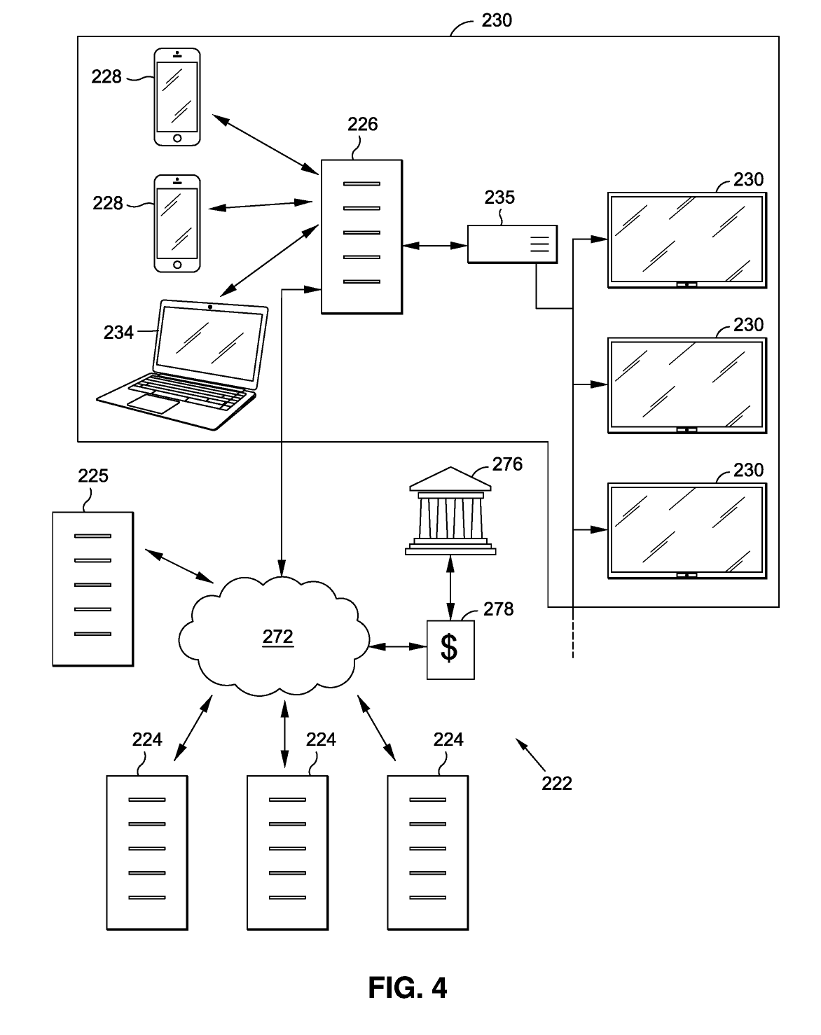

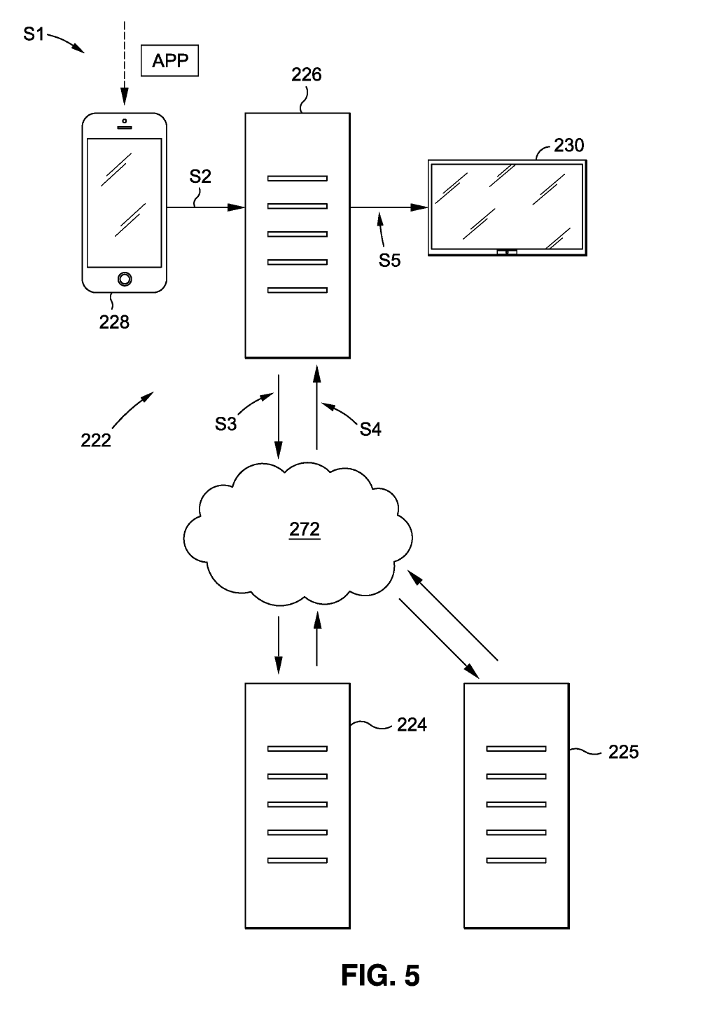

Another embodiment of a system 222 is illustrated in FIG. 4. In FIGS. 4 and 5 and in the following description, similar system elements to those described above have been given similar numbers, except assigned a “200” series number.

In this system 222, instead of the media control device 26 comprising a cloud-type server and using display controllers 36 as interfaces to the displays 30, the media control device 226 preferably comprise a local controller which is configured to obtain remotely sourced content (such as web-based media), such as streamlining video, from one or more webservers 224 and then distribute that content to the one or more video displays 230. In general, the media control device 226 receives control instructions from one or more user devices 228, 234 accesses web-based content based upon those instructions, such as via one or more webservers 224, and then generates an output which causes the one or more video displays 230 to display the desired content.

In this configuration, the media control device 226 is preferably configured to communicate with one or more third party webservers 224 or content supplier platforms, so as to receive or obtain content for display by the video display(s) 230. The media control device 226 may comprise a local computing device, such as a local server, such as which resides directly at the venue 230.

In this configuration, the media control device 226 may communicate directly with one or more user devices 228,234. For example, the user devices 228,234 might communicate with the media control device 226 via one or more wireless communication links (Wi-Fi, Bluetooth, etc.). In this configuration, the media control device 226 processes the instructions from the user devices 228,234 and then fetches content from the remote webservers 224, such as over the Internet 272.

The media control device 226 may then provide an output to each video display 230. In one embodiment, the system 222 may include at least one distribution hub 235 which is capable of receiving one or more video inputs and then directing them to one or more video displays 230. Such devices are well known.

Aspects of use/operation of the system 222 will now be described with reference to FIGS. 4 and 5. In one embodiment, a user downloads or installs a media control application on their user device 228, as at S1 in FIG. 5. For example, the user might use a browser on their user device s28 to access a server which allows the user to download the application.

Once the application has been downloaded, the user may execute the application. This may cause, for example, their user device 228 to display a graphical user interface. In one embodiment, the graphical user interface displays information to the user and allows the user to provide input. Preferably, the graphical user interface facilitates the user's location and selection of desired web-based content, such as video, to be displayed by one or more of the video displays 230 of the system 222.

As noted, in one embodiment, when the user provides inputs to their user device 228 via the application (see step S2 in FIG. 5), one or more of those inputs are preferably transmitted to the media control device 226, such as via the wireless communication link. Software running at the media control device 226 is configured to receive and process those inputs. As noted, for example, the user might select desired content from a particular webserver. The media control device 226 may then communicate with the desired webserver 24 to seek the content, as indicated at step S3 in FIG. 5. In response, the webserver 224 preferably transmits the desired content, such as by transmitting it over the Internet 272 to the media control device 226, such as at step S4.

The media control device 226 then preferably processes the content. In one embodiment, this may comprise turning the web-based content (such as HTML video) into other forms or formats, such as an HDMI video format or the like. This output is then transmitted by the media control device 226 to one or more designated video displays 230, either directly or via the distribution hub 235, such as at step S5 in FIG. 5.

This system 222 may also include audio presentation control features similar to those above, and may also allow for the presentation of primary and secondary content, such as secondary content provided from one or more secondary sources such as secondary web servers 225.

This system 222 has the same general advantages of the system 22 described above and may include other features, such as the payment features, advertising features and the like as also described above. However, these two systems 22,222 offer two different technical solutions to the problems identified herein, wherein these technical solutions have different benefits.

In the system 22 illustrated in FIG. 1 has an advantage that it is essentially infinitely scalable. For example, a venue might have two (2) video displays 30. The venue might then simply associate a display controller 36 with each of those displays. Then if the venue desired to control more displays, the operator only needs to add a display controller 36 to those new displays. As noted, the display controllers 36 might even be “plug and play”, thus requiring essentially no technical expertise to install. Also, the media control device 26 can be easily scaled and can be centrally updated or modified to provide additional features or services.

The system 222 illustrated in FIG. 4 has the advantage that it can be less bandwidth intensive. In particular, in the system 22 illustrated in FIG. 1, each display controller 36 must obtain a separate feed of content to be displayed. If a venue has a large number of video displays 30, the venue may quickly run out of data bandwidth, thus limiting the number of display controllers 36 which can be supported. On the other hand, in the system 222 illustrated in FIG. 4, data is transmitted to the media control device 226 which then feeds the video displays 230. In this configuration, if multiple of the video displays 230 display the same content, a single feed to the media display device 226 can be fed to multiple video displays 230.

In addition, the system 222 which is illustrated in FIG. 4 only requires a connection between a backroom media control device 226 and the video displays 230. This avoid, for example, problems associated with installing individual display controllers 36 at or near each video display 30,230 as is required by the system 22 illustrated in FIG. 1. For example, a casino will likely desire to have the media control device 226 located in a secure area and feed the displays 230, rather than have to mount display controllers 36 at each display 30,which may be practically difficult (such as where the displays are mounted on the walls and there is no room for such a controller 36) and to prevent theft or tampering with such controllers.

On the other hand, having the media control device 226 located at the venue in the system 222 illustrated in FIG. 4, the operator may need to employ specialized technicians to operate, service or update the device.

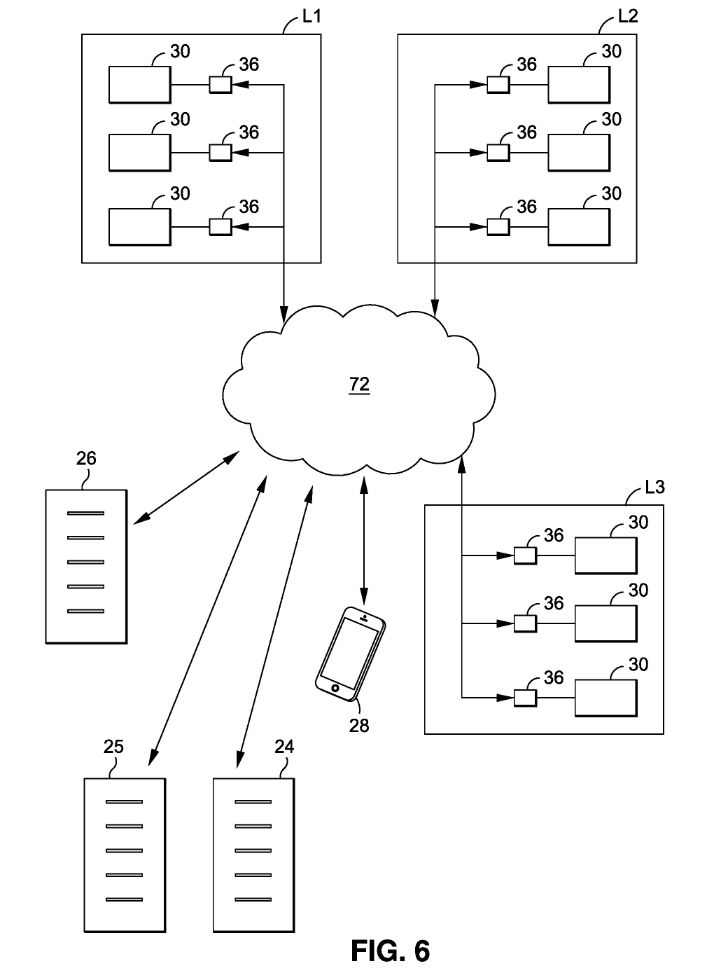

Referring to FIG. 6, one aspect of the invention is a scalable system wherein a single media control operator may enable media control at a plurality of locations. For example, the medial control operator may operate the one or more media control devices 26 (which might be owned, leased, etc.). For example, the media control operator might operate one or more servers which comprise the media control devices 26 and such may be at a first location. Individual operator locations L1, L2, L3, etc., which are remote from the media control operator location may all communicate with the media control device 26. For example, location L1 might be a sports bar in Las Vegas, N.V., location L2 might comprise a tavern in Seattle, Wash., and location L3 might comprise a bar in New York, N.Y. Each of those locations may have one or more displays 30 and/or audio generating devices which may be controlled in the manner which is described above.

A user may, as noted above, utilize an application or the like running on their user device 28 to interact with the system. In one embodiment, the user may select a display (or audio generating device) at a location they are patronizing. For example, if the user is at location L1, the graphical user interface which is displayed at the user's device may display options regarding the displays 30 which are located at only that location and then allow, subject to the various criteria noted above (operator control, any required payment, etc.), the user to select one of those displays 30 to have their selected content displayed on. In one embodiment, as noted above, the system may identify the available displays based upon user location information, such as location information obtained from the user's device 28. In one embodiment, each display 30 or sound generating device at each location L1, L2, L3, etc. may be uniquely identified in the system (such as via a tag, ID or the like, including associated with the display or its associated display controller). For example, in one embodiment, the location operator may utilize an Admin control interface, such as implemented by their user device 34, to assign or program each of the displays in their location with a unique ID (which ID may be assigned to the associated display controller 36 or TV controller, which also causes the display or TV to display the ID for user identification for selecting a desired display). In this manner, the system can filter for those displays which are at the location of the user, allow the user to select one of those displays and then cause information to be displayed by the particular selected display. In one embodiment, the system may cause the displays to display ID information, such as “Display 52”, so that a user in a location can identify which display they would like to select based upon its location, etc. For example, as detailed below, when a user operates their device at a particular location, the media control server 26 may, based upon location information of the user, provide a user with a list of displays at the location from which the user can choose. The user may then compare that list to the displays as identified in the location and select one of the displays. The media control server 26 may then cause the display controller 36 for the selected display to display the desired/selected content, as described herein.

FIGS. 1, 3 and 4 illustrate embodiments of systems where content is obtained primarily in digital form from webservers or the like. As indicated, such may comprise data, video (such as live or stored video), audio and the like. It will be appreciated, however, that an operator and/or use may desire to display or present content which is available from other sources. For example, in a sports bar environment, the content might comprise an audio-visual feed of a sports event over a cable or satellite network. Such content may be referred to as a “linear” feed or content.

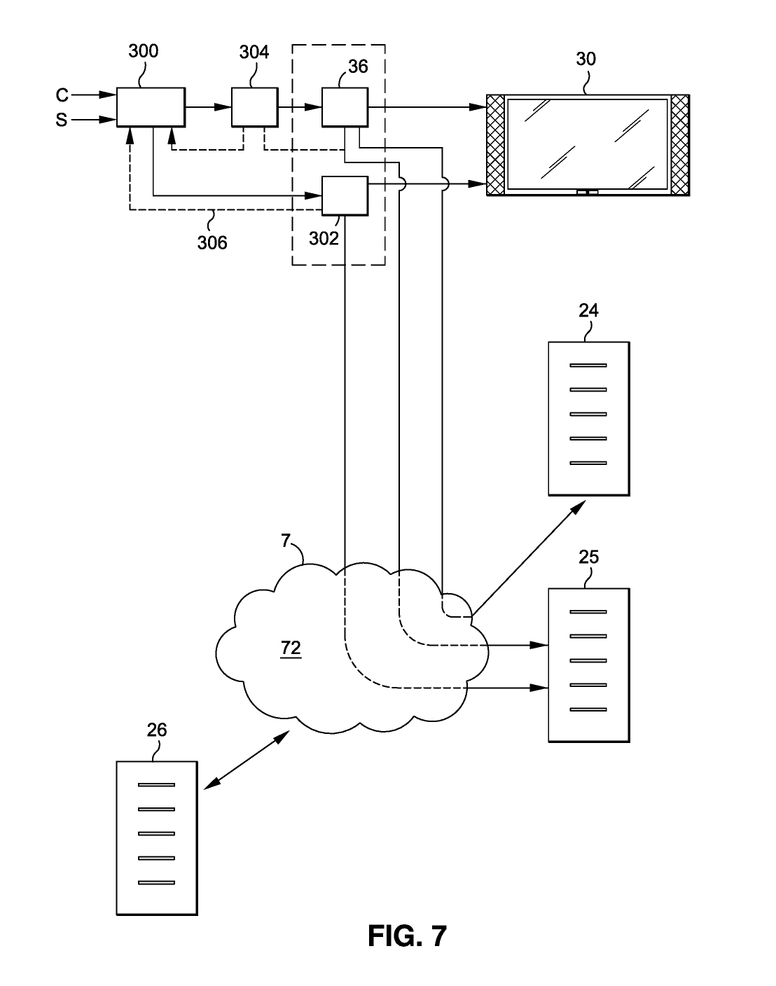

FIG. 7 illustrates one embodiment of a system of the invention where the primary content may comprise content which is available online and/or from a linear feed. In this embodiment, a cable feed C or satellite feed S may provide one or more channels of audio, video or audio-visual content. These feeds may be directed to a subscriber or decoder box 300. As is well-known, this box 300 may, such as based upon subscription information, enable access to one or more channels of the feed(s), such as by decoding the various channels in the feed.

In one embodiment, at least one controller interface 304 is provided between the subscriber box 300 and the display controller 36. The controller interface 304 may, for example, employ a Real Time Streaming Protocol (RTSP). The interface 304 may be used to convert an analog content output from the subscriber box 300 to a digital output which can be received by the display controller 36, and may be used to control the subscriber box 300, such as to change channels etc. Depending upon the configuration, more than one controller interface 304 may be required, such as a separate interface for each linear feed channel.

In this configuration, a user might user their user device 28 to select a particular satellite channel or feed for display on the display 30. The media control server 26 could cause the display controller 36 and/or the interface 304 to select the desired feed, such as from the subscriber box 300, thus causing a digital feed of the content to be supplied to the display controller 36. The display controller 36 might then combine that content with secondary or tertiary content or the like, such as from one or more webservers 24,25, for presentation on the display 30.

In another or additional configuration, the output of the subscriber box 300 may be directed to a scaler/combiner 302. Such a device 302 might comprise a BrightSign signage controller (from BrightSign, LLC; www.brightsign.biz). This device or controller 302 receives the output of the subscriber box 300 and combines it with secondary content (such as from one or more webservers 25), such as by scaling the subscriber box 300 feed to a reduce size and then incorporating the additional content (secondary/tertiary, etc.). This combined content may then be output to the display 30. Additionally, the device or controller 302 may provide control instructions to the subscriber box 300, such as to change the channel (such as via an IR signal 306).

As illustrated in FIG. 7, in some embodiments, the functionality of the display controller 36 and the scaler/combiner 302, might be integrated into a single control device. In this manner, a single solution may be provided which allows content (whether primary/secondary/tertiary, etc.) to be utilized and combined for display by the display, under operator and/or user control, regardless of the nature of the content or its source, including analog and/or digital.

It will be appreciated that features or aspects of the invention may be used in combination with one another, be used separately, and/or be combined with other features. For example, the audio presentation feature of the invention might be used even when the video presentation feature is not. As one example, a location might have a plurality of displays where the operator controls the display of content on those displays. The audio control feature of the system may be used to prevent audio conflicts, such as by allowing users to have audio content be routed to their user devices, headphones or closely located audio generating devices (rather than primary audio generating devices).

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A system for controlling the distribution of remotely sourced content for display, comprising:
a display controller associated with an electronic video display, said display controller comprising a processor, at least one first communication interface and a memory;
a media control device, said media control device comprising a processor, at least one second communication interface and a memory, said media control device configured to receive, via said at least one second communication interface, input from a portable user communication device of information relating to selected primary remotely sourced content, and to transmit control instructions via said at least one communication interface to said display controller based upon said input; and
said display controller configured to request said primary remotely sourced content from at least one remote webserver based upon said control instructions and, to receive, from said at least one webserver, streaming media content via said at least one first communication interface, and to generate a video output to said electronic video display of said streaming media content for display by said video display.

2. The system in accordance with claim 1 wherein said media control device comprises a cloud server.

3. The system in accordance with claim 1 wherein said media control device is further configured to receive input from said portable user communication device of information relating to at least one selected secondary remotely sourced content and said display controller is configured to request said at least one secondary remotely sourced content and generate a video output to said video display of said media content and said at least one secondary remotely sourced content.

4. The system in accordance with claim 3 wherein said primary remotely sourced content comprises a sports event program and said at least one secondary remotely source content comprises wagering or fantasy sports related information.

5. The system in accordance with claim 3 wherein said at least one secondary remotely sourced content is presented as a chyron to said primary remotely sourced content.

6. The system in accordance with claim 1 wherein said media control device is configured to control the distribution of audio associated with said content.

7. The system in accordance with claim 6 wherein said audio is distributed to either a primary audio generating device associated with said video display or a secondary audio generating device which is remote from said video display.

8. The system in accordance with claim 3 wherein said primary remotely source content and said at least one selected secondary remotely sourced content comprises at least one of a video feed, wagering information, sports data, and information from a social media account.

9. The system in accordance with claim 1 wherein said input from said portable user communication device of information relating to selected remotely sourced content is an input provided to an application which is downloaded to said portable user communication device and running on said device.

10. A system for controlling the distribution of web-based content for display, comprising:
at least one electronic video display; and
a media control device, said media control device comprising:
a processor;
at least one communication interface;
a memory; and
machine-readable program code stored in said memory configured to:
receive input from a portable user communication device, via a wireless communication link with said portable user communication device with said at least one communication interface, of information relating to primary remotely sourced content;
transmit an output from said at least one communication interface over a second communication link comprising the Internet to at least one first webserver requesting said primary remotely sourced content;
receive, from said at least one first webserver, primary streaming media content, via said at least one communication interface; and
generate a video output to said at least one electronic video display of said primary streaming media content for display by said at least one video display.

11. The system in accordance with claim 10 further comprising a video distribution hub, wherein said video output is provided to said video distribution hub and said video distribution hub provides an output to said at least one video display.

12. A system for controlling the distribution of remotely sourced content for display, comprising:
a first display controller associated with a first electronic video display, said first display controller comprising a processor, at least one first communication interface and a memory;
a media control device, said media control device comprising a processor, at least one second communication interface and a memory, said media control device configured to receive, via said at least one second communication interface, input from a first portable user communication device of information relating to a first user selected primary remotely sourced content, and to transmit control instructions via said at least one communication interface to said first display controller based upon said input; and
said first display controller configured to request said first user selected primary remotely sourced content based upon said control instructions and, to receive, first user selected primary remotely sourced content via said at least one first communication interface, and to generate a video output to said first electronic video display of said first user selected primary remotely sourced content for display by said first electronic video display.

13. The system in accordance with claim 12 further comprising a controller interface, wherein said first display controller receives said first user selected primary remotely sourced content from said controller interface and said first user selected primary remotely source content comprises a linear cable or satellite feed provided to said controller interface.

14. The system in accordance with claim 13 wherein said controller interface utilizes an RTSP protocol and receives a video feed input from the output of a decoder box.

15. The system in accordance with claim 12 wherein said input from said first portable user communication device is received from said device running a downloaded user control application.

16. The system in accordance with claim 12 wherein said media control device is further configured to receive input from said first portable user communication device of information relating to at least one selected secondary remotely sourced content and said first display controller is configured to request said at least one secondary remotely sourced content and generate a video output to said video display of said first user selected primary remotely sourced content and said at least one secondary remotely sourced content.

17. The system in accordance with claim 16 wherein said first user selected primary remotely content comprises a video feed of a sports event and said secondary remotely sourced content comprises at least one of sports statistics, sports betting information, social media account information and photos.

18. The system in accordance with claim 12 further comprising a second display controller associated with a second electronic video display, said second display controller comprising a processor, at least one first communication interface and a memory, wherein said media control device is further configured to receive, via said at least one second communication interface, input from a second portable user communication device of information relating to second user selected primary remotely sourced content, and to transmit control instructions via said at least one communication interface to said second display controller based upon said input, and wherein said second display controller configured to request said second user selected primary remotely sourced content based upon said control instructions and, to receive primary remotely sourced content via said at least one first communication interface, and to generate a video output to said second electronic video display of said second user selected primary remotely sourced content for display by said second electronic video display.

19. The system in accordance with claim 18 wherein said first and second electronic video displays are located at different retail establishments.

20. The system in accordance with claim 18 wherein said media control device is configured to process a payment from said user of said first portable user communicate device to cause said system to display said first user selected primary remotely sourced content at said first electronic video display.
